(19) United States
(12) Patent Application Publication
(10) Pub. No.: US 2007/0085352 A1
(43) Pub. Date: Apr. 19, 2007

(54) Door latch

(76) Inventors: Ross De Guzman Ulanday, Torrance, CA (US); Aurora Bergado Ulanday, Torrance, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/250,912

(22) Filed: Oct. 14, 2005

(51) Int. Cl. E05C 19/18

(52) U.S. Cl. 292/288

(57) ABSTRACT

The present invention is a simple and effective door latch that improves the strength and security of a door. The device utilizes a central segment with an attached slide lock and a strike plate, wherein the strike plate of the door latch can replace any standard strike plate present in an existing doorjamb. Once the device is attached to the doorjamb, the slide lock is then secured to the door handle by the narrow segment of the handle clip. The device is adjustable to allow for variations in the size of door handles.

### BACKGROUND OF THE INVENTION

1. Field of the Invention

The present invention relates to the field of door locking mechanisms. Specifically, the invention is designed to provide added security to individual's attempting to gain unauthorized access to one's home or business by increasing the strength of one's door.

2. Description of Related Art

Door locks have been used for hundreds of years to protect individual's homes, businesses, and personal possessions from intruders and thieves. Throughout this period, a multitude of lock designs have emerged that have attempted to provide increased security by increasing the resilience of a standard door from forcible entry. For example, other inventors have created numerous variations of the deadlock and key design, the deadbolt lock and pass code systems. Despite these attempts, most standard home lock devices fail after receiving a high impact blow to the door. When compared to the prior art below, it is clear that the present invention improves upon the standard door lock.

U.S. patent application 2002/0067046 published on Jun. 6, 2002 discloses a locking mechanism that is anchored to a door jamb and attached to the corresponding door knob. This provides increased strength and security to the user. The present invention improves on this prior art by providing a slide lock system that allows the user to partially open the door when someone comes to the door. In addition, the present invention is much easier to user due to the simple slide lock system employed. In order to unlock the device, the user must remove a series of screws and unhook the device. This can be both cumbersome and time consuming.

U.S. Pat. No. 5,462,319 issued Oct. 31, 1995 to inventor Ralph Roden discloses a lock for an inswinging door. The prior art employs a retaining plate affixed to the doorjamb combined with a locking plate to secure the retaining plate. This device is very large and can be cumbersome to use. The present invention improves on this idea by providing a compact, easy-to-use locking device. Furthermore, this prior art does not provide a locking mechanism for a standard door that requires a knob or handle to open.

U.S. patent application 2002/0021011 published on Feb. 21, 2002 discloses a locking mechanism with a striker having an enlarged head and a keep. The keep retains the head of a striker in a locked or latched condition. This device merely prevents the handle from being tampered with and opened rather than providing extra support for the door itself. The present invention fully supports the door and provides added protection against intruders when the standard bolt lock is breached.

In light of these improvements, the present invention clearly creates a strengthened lock and door system. Further advantages to using such system will become more apparent in the specifications.

### BRIEF SUMMARY OF THE INVENTION

The present invention is a simple and effective door latch that improves the strength and security of a door. The device utilizes a central segment with an attached slide lock and a strike plate, wherein the strike plate of the door latch can replace any standard strike plate present in an existing doorjamb. Once the device is attached to the doorjamb, the slide lock is then secured to the door handle by the narrow segment of the handle clip. The device is adjustable to allow for variations in the size of door handles.

It is therefore, the object of the present invention to provide a locking device that provides increased tensile strength and security for a door.

A further object of the present invention is to provide a locking mechanism for a standard door handle that is a strong deterrent to forced entry to a home or business.

A further object of the present invention is to provide a slide lock that allows the user to partially open the door and view the exterior while the door latch is secured to the handle.

Another object of the present invention is to provide an improved locking mechanism that is inexpensive and easy to use.

Another object of the present invention is to provide an improved locking device that is adjustable to allow variations in the sizes and shapes of different door handles.

A further object of the present invention is to provide a locking mechanism that conformably attaches from the doorjamb to the door handle.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an overhead view of the door latch.

FIG. 1a is a perspective view of the door latch when viewed from a side position.

FIG. 1b is an overhead view of the tamper protection plate.

FIG. 1c is a perspective view of the tamper protection plate when viewed from a side position.

FIG. 2 is a perspective view of the door latch when attached to the interior doorjamb and standard household knob.

FIG. 3 is an overhead view of an alternate embodiment of the door latch with an extended handle clip capable of supporting an elongated door handle.

FIG. 3a is a perspective view of the alternate embodiment with extended handle clip when viewed from the side.

FIG. 3b is an overhead view of a tightening clap, which secures the extended handle clip of the alternate embodiment to the door handle.

FIG. 3c is a side view of the aforementioned tightening clasp.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

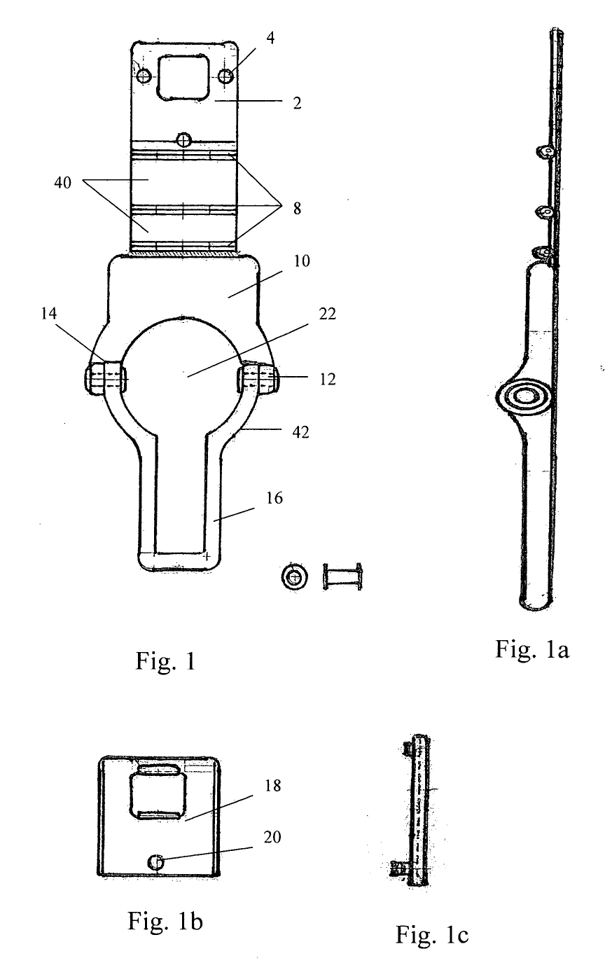

Referring to FIGS. 1 and 1a, this illustrates an overhead view and corresponding side view of the door latch. A central segment 6—which in a preferred embodiment comprises a plurality of support braces 40 sequentially attached by a series of hinges 8—is fixedly attached to a strike plate 2 and a slide lock 42 at a first and second end, respectively. This configuration results in an elongated door latch that is attached to a doorjamb by the strike plate 2 and secured to a corresponding door handle by the slide lock 42. Preferably, this door latch is comprised of a strong metal such as hardened steel to provide added resilience to external forces.

The strike plate 2, located on the door latch, replaces the original strike plate and is removably attached to the doorjamb by two lock screws 4. In order to prevent the door latch from being tampered with, a removable tamper protection plate 18 is clipped onto the strike plate 2 and secured by a plate screw 20. This plate screw 20 is affixed so that the head of the plate screw 20 is positioned on the interior side of the door. FIGS. 1b and 1c illustrates the tamper protection plate 18 from an overhead and side perspective.

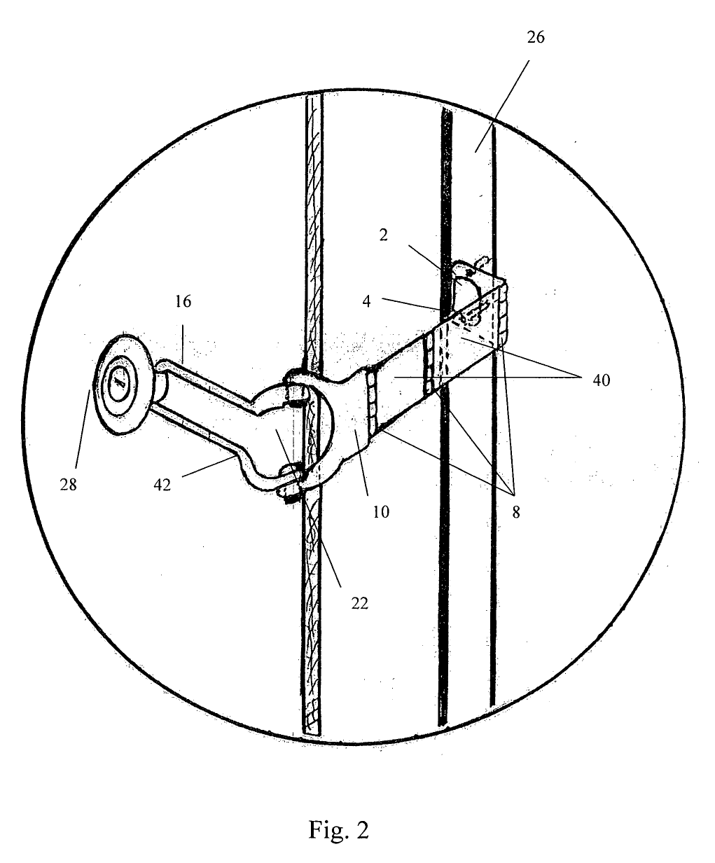

As seen in FIG. 1, the slide lock 42 is composed of two components, a lock joint 10 and a handle clip 16 that are pivotably attached by two rivets 12. This creates two pivot points 14 located on opposite sides of the slide lock 42, which allows the handle clip 16 to wrap around the side of the door when it is in an open position. Within the slide lock 42 is a large open segment 22 that comprises a wide aperture contiguous with a corresponding narrow aperture. The slide lock 42 is secured to the door by placing the wide aperture—which in a preferred embodiment is shaped to encompass a standard door knob—over the handle and sliding the handle along the narrow aperture of the slide lock 42. The end result of this process can be viewed in FIG. 2.

Referring to FIG. 2, this illustrates a partially open door with the door latch properly secured. The lock screws 4 attach the strike plate 2 of the door latch to the interior door frame 26. Once attached, the slide lock 42 is secured to the door by fitting the wide aperture over the door knob 28 and sliding the door knob 28 to the end of the handle clip 16. The central segment 6—which in a preferred embodiment is sufficiently flexible to permit the attachment of the slide lock to the door handle—is a sufficient length so as to allow the door to be partially opened in order to obtain the identity and purpose of a visitor. When the door is opened, the slide lock 42 pivotably wraps around the exterior portion of the door at its pivot points 14, thereby allowing the slide lock 42 to remain in place while the door is ajar. Thus, the door latch operates as a secondary locking mechanism when the door must be opened to address the needs of the visitor.

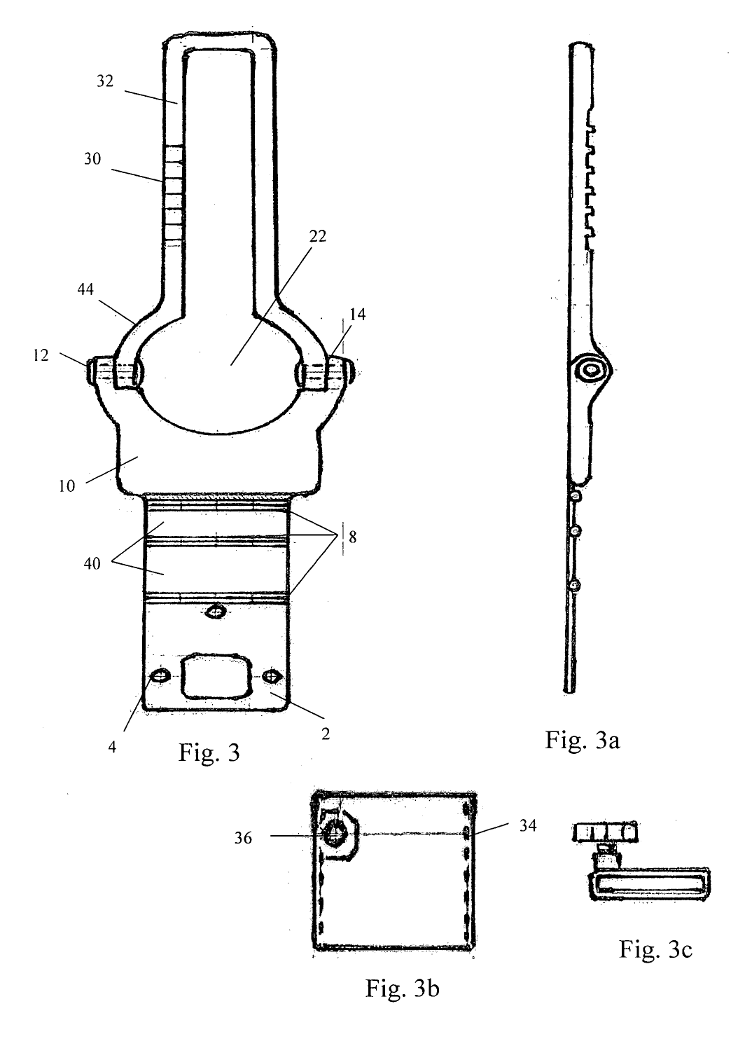

FIGS. 3 and 3a illustrates an alternate embodiment of the door latch with an extended handle clip 32. The extended handle clip 32 allows for the attachment of varying elongated door handles that are not compatible with the preferred embodiment described above. Similar to the preferred embodiment, the extended door latch secures a door by attaching the strike plate 2 to a door jamb and the extended slide lock 44 to the corresponding handle. Since the door handle is not capable of sliding along the narrow aperture, the extended slide lock 44 is affixed to the handle by employing a tightening clasp 34, which is depicted in FIGS. 3b and 3c. The tightening clasp 34 comprises a stabilizer pin 36 that is screwed through the tightening clasp 34 down to an appropriate ridge 30. This prevents the removal of the extended slide lock 44 from its secured position.

In yet another embodiment of the invention, the handle clip 16 is adjustable so as to conform to the varying shapes and sizes of any door handle or knob. Positioned on the handle clip 16 are similar ridges 30 as those described above; however, the handle clip 16 itself possesses the stabilizer pin 36. This allows the handle clip 16 to adjust depending on the size of the appropriate handle without the use of a tightening clasp 34.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. a door latch, comprising;
a central segment comprising a first end and a second end;
a strike plate fixedly attached at said first end;
wherein said strike plate is removably attached to the interior portion of a doorjamb;
a slide lock attached at said second end;
wherein said slide lock comprises an open segment with a wide aperture contiguous to a narrow aperture; and
wherein said central segment is sufficiently flexible to permit attachment of said slide lock to the door handle.

2. The door latch of claim 1, wherein said door latch is composed of metal.

3. The door latch of claim 2, wherein said door latch is composed of hardened steel.

4. The door latch of claim 1, wherein said slide lock is comprised of a lock joint and a handle clip; and
wherein said handle clip is pivotably attached to said lock joint.

5. The door latch of claim 1, wherein said central segment comprises a plurality support braces sequentially attached by a series of hinges.

6. The door latch of claim 1, wherein a tamper protection plate is removably attached to said strike plate.

7. The door latch of claim 1, wherein said wide aperture of the slide lock is capable of encompassing a standard door knob; and
wherein said door latch is secured by sliding said door knob along said narrow aperture of the slide lock.

8. The door latch of claim 1, wherein said slide lock is elongated, thereby allowing attachment of said door latch to a door handle.

9. The door latch of claim 8, wherein said slide lock has a plurality of ridges positioned on said narrow aperture of the slide lock.

10. The door latch of claim 9, wherein a tightening clasp secures said slide lock to said door handle by said ridges and a stabilizer pin.

11. The door latch of claim 1, wherein said slide lock is adjustable so as to increase the length of said narrow portion.

12. A metal door latch, comprising;
a central segment comprising a first end and a second end;
a strike plate fixedly attached at said first end;
wherein said strike plate is removably attached to the interior portion of a doorjamb;
a slide lock attached at said second end;
wherein said slide lock comprises an open segment with a wide, circular aperture contiguous to a narrow, rectangular aperture;
wherein said central segment is sufficiently flexible to permit attachment of said slide lock to the door handle; and,
wherein said door latch permits the user to partially open said door, while said door latch is secured.
